(19) United States
(12) Patent Application Publication
(10) Pub. No.: US 2009/0208763 A1
(43) Pub. Date: Aug. 20, 2009

(54) SYSTEMS AND METHODS FOR STAINING SURFACES

(76) Inventor: Troy Harris, Pleasant View, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/116,777

(22) Filed: May 7, 2008

Related U.S. Application Data
(60) Provisional application No. 61/029,243, filed on Feb. 15, 2008.

(51) Int. Cl. B32B 15/08; C08K 3/10; B05D 7/02

(52) U.S. Cl. 428/461; 524/401; 427/419.8

(57) ABSTRACT

Systems and methods of staining a surface. An organic salt is used in combination with a metal salt to provide a decorative stain that can be used to stain any of a variety of pH basic surfaces, including concrete. In at least some implementations, urea hydrochloride or an equivalent thereof is used as an organic salt in combination with a metal salt to create an alkali reactive decorative stain that can be used to stain any of a variety of pH basic surfaces, including concrete. The urea hydrochloride is safe and environmentally fit to use. Different metal salts are used and/or mixed to obtain a desired color and/or appearance.

### RELATED APPLICATIONS

This application claims the benefit of U.S. Provisional Application No. 61/029,243, filed Feb. 15, 2008, entitled SYSTEMS AND METHODS FOR STAINING SURFACES, which is incorporated herein by reference.

### BACKGROUND OF THE INVENTION

1. Field of the Invention

The present invention relates to staining surfaces. In particular, the present invention relates to systems and methods for using an organic salt in combination with a metal salt to provide a decorative stain that can be used to stain any of a variety of pH basic surfaces, including concrete. Further, at least some implementations of the present invention embrace using urea hydrochloride or an equivalent thereof as an organic salt in combination with a metal salt to create an alkali reactive decorative stain that can be used to stain any of a variety of pH basic surfaces, including concrete.

2. Background and Related Art

Concrete is a building material utilized in a variety of applications. For example, concrete is used in foundations, walls, floors, countertops, fireplaces, swimming pools, patios, exterior walls, retaining walls as well as other applications that require a low cost, strong material. The concrete may be reinforced with rebar or other materials to increase its tinsel strength.

A drawback in utilizing concrete is its lack of aesthetic appeal. Concrete's appearance is masked by painting the concrete surface, texturing the concrete surface, or using vegetation, stone, brick, wood or tile to cover the concrete surface. Such attempts may be expensive, time consuming to maintain, and ineffective. For example, paint applied to concrete surfaces often peels as the concrete decays. Stone, brick or tile used to cover the concrete is expensive. Wood or other facade materials can create water traps between the cement and the fagade. Vegetation coverings require constant maintenance. As a result, such strategies to cover concrete's appearance are often undesirable.

Concrete stains with hydrochloric acid (“HCl”) have been utilized, however the HCl acid is a highly corrosive and dangerous substance that can be costly and dangerous to transport. In addition, special training and/or precautions are required, thus limiting those who can use the HCl acid stain. Furthermore, HCl acid can potentially damage a concrete surface. For example, when a concentration of the HCl acid is too strong, the stain can pit the concrete's surface, opening the concrete to water damage including freeze/crack cycle as well as other potentially damaging conditions.

Thus, while techniques currently exist for the utilization of concrete in a variety of applications, challenges still exist. Accordingly, it would be an improvement in the art to augment or even replace current techniques with other techniques.

### SUMMARY OF THE INVENTION

The present invention relates to staining surfaces. In particular, the present invention relates to systems and methods for using an organic salt in combination with a metal salt to provide an alkali reactive decorative stain that can be used to stain any of a variety of pH basic surfaces, including concrete.

At least some implementations of the present invention embrace using urea hydrochloride or an equivalent thereof as an organic salt in combination with a metal salt to create the alkali reactive decorative stain that can be used to stain any of a variety of pH basic surfaces, including concrete. More particularly, at least one implementation of the present invention embraces a stain having urea hydrochloride, a metal salt and water for application to a surface. In at least some implementations, the surface is a concrete surface. Certain metal salts when mixed with the organic salt, such as urea hydrochloride or an equivalent thereof, cause the concrete surface to change to a particular color. Accordingly, specific designs and color patterns can be created in and/or on the surface.

In some implementations, a user applies the urea hydrochloride stain solution to a concrete surface and then washes off concrete surface onto the surrounding ground. The use of urea hydrochloride greatly reduces the health and safety risks associated with staining concrete, and is more environmental friendly than traditional methods. In addition, less water is needed with urea hydrochloride, thus helping conserve water.

While the methods and processes of the present invention have proven to be particularly useful in the area of staining a concrete surface, those skilled in the art can appreciate that the methods and processes can be used in a variety of different applications and in a variety of different areas of manufacture to yield stained surfaces. Representative examples include commercial restaurant eating areas, inside and outside flooring, stamped concrete, stamped and/or textured cementitious overlays, concrete countertops, vertical concrete applications, concrete building exteriors, statuary, hotel and lobby areas, and other surfaces, including any concrete surface desiring an aged, antiqued appearance from new or existing concrete.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative method suitable for staining a surface in accordance with a representative embodiment of the present invention.

### DETAILED DESCRIPTION OF THE INVENTION

The present invention relates to staining surfaces. In particular, the present invention relates to systems and methods for using an organic salt in combination with a metal salt to provide a decorative stain that can be used to stain any of a variety of pH basic surfaces, including concrete. Further, at least some embodiments of the present invention embrace using urea hydrochloride, or an equivalent thereof, as an organic salt in combination with a metal salt to create an alkali reactive decorative stain that can be used to stain any of a variety of pH basic surfaces, including concrete.

In the disclosure and in the claims the term “concrete” shall include substrates comprising cement and hydrated lime (calcium hydroxide) compositions specifically and substrates having a pH greater than 7.

At least some embodiments of the present invention embrace a surface stain that comprises urea hydrochloride (CH₄N₂O.HCl). Urea hydrochloride is a representative organic salt. Unlike traditional acid-based solutions, which are highly corrosive, urea hydrochloride is a mild skin irritant, milder for end users than product formulas based on HCl acid. Additionally, the urea hydrochloride does not emit fumes.

The following is a representative example of the chemical composition for urea hydrochloride:

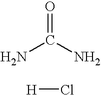

Urea hydrochloride offers many advantages. It is safer to use and is not as corrosive, thus a practitioner can use the urea hydrochloride without fear of being chemically burned. Urea hydrochloride can be transported without excessive oversight, thus reducing costs associated with using an HCl acid based material.

Urea hydrochloride reacts with alkali surfaces typically 20-30% less than HCl in terms of actual measurable corrosivity. Thus, a broader population segment is able to practice concrete staining using urea hydrochloride because special training, permits or precautions are not required. This broadens the market of people who can use and enjoy the medium.

The urea hydrochloride may have any concentration; however practical and stoichiometric limits are set by the reactants in the concrete and the stain including the reaction with the metal salts. In at least some embodiments, practicable urea hydrochloride concentrations may have a pH of approximately 1, but may be varied between 1 and 3.

In an alternate embodiment, a salt that is formed by the combination of a strong acid with a weak base is used in place of urea hydrochloride. Strong acids are acids that are completely ionized in water. Ebbing, D. D., and Wrighton, M. S., “General Chemistry, Second Edition,” Houghton Mifflin Company, Boston, pp. 327 (1987). Therefore, in one embodiment the strong acid is a mineral acid comprising nitric, hydrochloric, hydrobromic, hydroiodic, hydrofluoric, or the like.. In another embodiment, the acid a “weak” acid comprising formic, acetic, hydroxyacetic, thioglycolic acid, or the like.

Weak bases are bases that are completely ionized in water. Ebbing, D. D., and Wrighton, M. S., “General Chemistry, Second Edition,” Houghton Mifflin Company, Boston, pp. 327 (1987). Nonlimiting examples of organic bases are found on pages 8-37 through 8-39 in the “CR Handbook of Chemistry and Physics,” 72^{nd} Edition, CRC Press, (1992), hereby incorporated by reference. Examples of weak bases include urea, acetylurea, alkonolamines, including triethanolamine, diethanolamine, monoethanolamine, HO-[(alkyl)O]ₓ—CH₂)_{y}NH₂, including HO—[(CH₂)ₓO]—CH₂)ₓNH₂], or the like, wherein the alkyl group can vary within the moiety, wherein x is 1-8 (which can vary within the 5 moiety) and y is an integer of 1 to 40; alkylamines (including methylamine, ethylamine, propylamine, butylamine, and the like), dialkylamines, alkyldiamines (including ethylenediamine), alkyltriamines, alkyltetramines, and trialkylamines, polymers with amino or (alkyl or aryl) amino substituent groups, including (mono or di)-alkylaminoalkylacrylate, and (mono or di) alkylaminoalkylmethacrylate, polymers with nitrogen-containing heterocyclic groups (including but not limited to pyridine, pyrimidine, imidazole, tetrazole, pyrazine, quinoline, isoquinoline, indole, isoindole, benzimidazole, purine, pyrrole, is pyrazole, quinazoline, pyridazine, pyrazine, cinnoline, phthalazine, quinoxaline, xanthine, hypoxanthine, and pteridine); amides, including formamide, acetamide, acrylamide, polymers and copolymers of acrylamide, and cyclic amides such as caprolactam; pyrollidone, polyvinyl pyrollidone, copolymers of vinyl pyrollidone, methacrylamide, polymethacrylamide, copolymers of methacrylamide, ammonia, guanidine, hydroxyurea, semicarbazide; mono-, di-, or tri(alkyl or aryl)urea, and wherein in the case of di(alkyl or aryl)urea the alkyl or aryl groups can be on the same or different nitrogen atoms, O-methyl hydroxyl amine (methoxylamine), aniline, and hydrazine.

Examples of suitable salts include any salt that is formed by the combination of one or more of the types of acids as listed above with one or more of the types of bases as listed above, in any desired molar ratio. Examples specifically include urea hydrogen nitrate, ammonium chloride, urea hydrobromide, ureahydroiodide, urea hydrofluoride, formamide hydrochloride, and the HCl, HI, HBr, or HF salts of pyrollidone or polyvinylpyrollidone.

As a non-limiting example, a 1:1 HCl salt of polyvinylpyrollidone (PVP) can be prepared by mixing 36 grams of 20 degree baume HCl with 36 grams of PVP (average MW 29,800) and 28 grams of water.

A useful composition is a mixture of HCl, HNO3, and urea, in any selected ratio. Mixtures of HCl and HNO3 are known as aqua regia, a very strong acid that can dissolve almost any material, including gold. HCI/HNO3 mixtures are commonly used to clean very dirty equipment. A disadvantage of HCI/HNO3 is its extreme corrosiveness and its noxious fumes. A mixture of HCl, HNO3, and urea provides the benefits of aqua regia while minimizing its corrosiveness and fumes. In a preferred composition, an amount of urea or other weak base, or combination thereof, is used that is at least equal to, and preferably greater than, the combined acid units of HCl and HNO3 based on equivalents.

Any molar ratio of strong acid to weak base that serves the desired purpose can be used within the scope of this invention. Typical ratios, in terms of acid or base equivalents, are typically between approximately 4 to 1 and 1 to 4 acid:base equivalent units or a slight excess of base, in equivalence units. As with urea hydrochloride, at least one equivalent unit of base, or a slight excess of base, per equivalent unit of acid, is preferred.

Any metal salt may be used in the staining process. Examples of effective metal salts (and the colors that result from use) include: sodium pernanganate (purple), ferrous chloride (red); ferric chloride (orange); sodium dichromate and manganese chloride (combined to blacken); and cupric chloride (green) to name a few. Others may further comprise: sodium sulphate, chromium potassium sulphate, potassium permanganate, black iron oxide, manganese oxide, red iron oxide, yellow iron oxide, ferric chloride solution, iron ore, sulfuric acid, barium sulfate, phosphoric acid, and vanadium trioxide. (See No. 566757 to Marvin T. Dodson). Indeed, any metal salt commonly known in the chemical art may be used. Using these basic ingredients, a practitioner can mix or amalgamate various ingredients to create a variety of colors. An alternative embodiment further comprises using a computer operated mixer to select and mix the basic ingredients of the solution. An alternative embodiment may further include using six (6) color shades based on six (6) different salts.

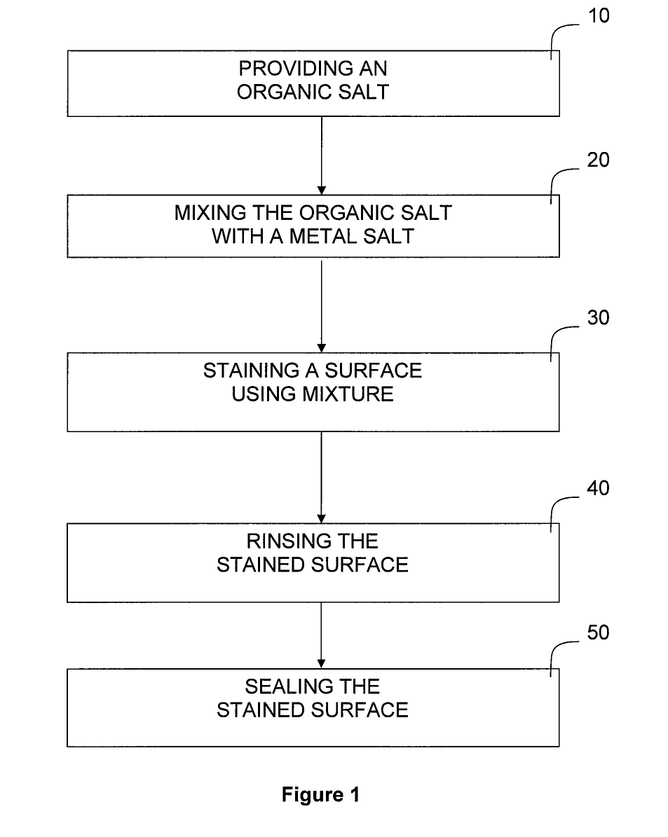

Referring now to FIG. 1, a process is set forth for treating and staining a concrete surface. While specific steps are illustrated, one of skill in the art will appreciate that the order of the steps may be varied within the scope of the present invention. Also, additional steps, including applying additional materials, are further anticipated within the scope of this invention. At step 10, an organic salt, such as a urea hydrochloride solution, is provided. As previously discussed, the urea hydrochloride solution may be successfully substituted by a variety of equivalent materials. Furthermore, one of skill in the art will appreciate that additional equivalent materials may exist other than those listed above.

At step 20, the organic salt is mixed with a metal salt or a combination of metal salts. The inclusion of the one or more metal salts provides a desired color and/or effect. Thus, as discussed above, the practitioner may select and mix any number of metal salts thereby customizing colors and textures within the final treated concrete. For example, in one embodiment the practitioner provides a mixture of sodium dichromate and manganese chloride to provide a blackening of the concrete surface. In another embodiment, the practitioner includes sodium permanganate in the mix to provide a purple color to the treated concrete surface.

At step 30, concrete surface is stained by applying the mixture of step 20. In many circumstances, an aqueous solution comprising urea hydrochloride and a metal salt is applied directly to the substrate's surface. Different solutions can be applied either serially or at the same time. One alternative method for applying the solution is to mix the solution and spray it on the concrete surface using a pressurized plastic spray bottle. Alternative application methods further comprise mixing a solution and applying it with a paint roller, paint brush, rag or other application technique. As with painting, different application methods will modulate the appearance of the stain. Furthermore, different amounts of stain will modulate the appearance of the cement. The concrete's innate property which is typically alkali (base) will further modulate the appearance of the stain. The stain can be applied using a stencil, or alternatively, the stain can also be applied in a manner similar to paint.

In a normal application, the urea hydrochloride stain quickly reacts with the concrete, depending on temperature and other ambient conditions. Once the application is complete, the residual solution is rinsed off the substrate or concrete surface at step 40 using an appropriate solvent. For example, water is a solvent that can be used to accomplish this step. The concrete surface may be rinsed using a hose and a sprayer, or may be rinsed by simple flowing water over the surface of the treated concrete. Once rinsed, the concrete surface can be mopped and allowed to dry. Once dry, the treated concrete surface is coated and/or sealed at step 50. For example, the treated concrete is coated or sealed using an acrylic, polyurethane, epoxy or other sealants commonly known in the art. Sealers generally provide improved resistance to weather, water, stains, and abrasives. Sealers also offer resistance to rain, sun, freezing temperatures, petroleum, and deicing salts. Concrete sealers may also make clean up easier.

Sealer may be selected and applied based on the intended use of the treated concrete. For example, multiple coats of a clear water-based lacquer, flat or gloss, may be applied for interior use. For exterior decoration, a solvent based lacquer may be preferred based the increased durability and water resistance of the sealant material. For very high traffic or commercial indoor use, a two-part epoxy or two-part polyurethane sealer may be preferred. For very high or commercial outdoor traffic, a strong and durable sealer may be preferred. Additionally, a user may desire to maintain the treated surface by annually recoating the treated surface after 5-8 years of traffic. Finally, a sealant or coating may be selected to include a resistance to ultraviolet (UV) light. For example, in one embodiment an epoxy having UV resistance is selected. In another embodiment, a polyaspartic polyurea coating having UV resistance is selected.

The following is intended to provide a general description of a suitable operating environment in which the invention may be implemented. One skilled in the art will appreciate that the invention may be practiced in different mixtures and different ratios using an aqueous solution comprising urea hydrochloride, or equivalents thereof, and a metal salt.

At least some embodiments of the present invention embrace mixing approximately 0.2-0.6 liters of urea hydrochloride, approximately 20-500 grams metal salt and approximately 0.5-3.5 liters of water. The solution is mixed in a container which is then pressurized and applied to a substrate such as concrete. The residue is then removed; the substrate is washed, dried and sealed using a sealant commonly known in the art.

An alternative embodiment of the stain may substitute masonry such as alkali bricks or alkali stone, alkali paint or other suitably reactive substrates.

Thus, as discussed herein, the embodiments of the present invention embrace surface stains. In particular, embodiments of the present invention relate to systems and methods for using an organic salt in combination with a metal salt to provide a decorative stain that can be used to stain any of a variety of pH basic surfaces, including concrete. Further, at least some embodiments of the present invention embrace using urea hydrochloride or an equivalent thereof as an organic salt in combination with a metal salt to create an alkali reactive decorative stain that can be used to stain any of a variety of pH basic surfaces, including concrete.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A composition for staining an alkali surface, the composition comprising an: organic salt for use in combination with at least one metal salt.

2. A composition for staining an alkali surface as recited in claim 1, wherein the organic salt is formed by the combination of at least one strong acid and at least one weak base, and wherein the at least one strong acid is one of: nitric acid, hydrochloric acid, hydorbromic acid, hydroiodic acid, hydrofluoric acid, formic acid, acetic acid, hydroxyacetic acid, and thioglycolic acid.

3. A composition for staining an alkali surface as recited in claim 2, wherein the at least one weak base is one of: urea, acetylurea, an alkonolamine, an alkylamine, an alkyltriamine, an alkyltetramine, a trialkylamine, a polymer having an amino substituent group, a polymer having a nitrogen-containing heterocyclic group, an amide, a cyclic amide, a pyrollidone, a polyvinyl pyrollidone, a copolymer of vinyl pyrollidone, a methacrylamide, a polymethacrylamide, a copolymer of methacrylamide, ammonia, guanidine, hydroxyurea, semicarbazide, methoxylamine, aniline, and hydrazine.

4. A composition for staining an alkali surface as recited in claim 3, wherein the alkonolamine is one of: triethanolamine, diethanolamine, and monoethanolamine.

5. A composition for staining an alkali surface as recited in claim 3, wherein the polymer having a nitrogen-containing heterocyclic group includes pyridine, pyrimidine, imidazole, tetrazole, pyrazine, quinoline, isoquinoline, indole, isoindole, benzimidazole, purine, pyrrole, isopyrazole, quinazoline, pyridazine, pyrazine, cinnoline, phthalazine, quinoxaline, xanthine, hypoxanthine, and pteridine.

6. A composition for staining an alkali surface as recited in claim 3, wherein the amide is one of formamide, acetamide, acrylamide, a polymer acrylamide, and a copolymer of acrylamide.

7. A composition for staining an alkali surface as recited in claim 3, wherein the cyclic amide is caprolactam.

8. A composition for staining an alkali surface as recited in claim 1, wherein the metal salt is at least one of: sodium permanganate, ferrous chloride, ferric chloride, sodium dichromate, manganese chloride, cupric chloride, sodium sulphate, chromium potassium sulphate, potassium permanganate, black iron oxide, manganese oxide, red iron oxide, yellow iron oxide, ferric chloride solution, iron ore, sulfuric acid, barium sulfate, phosphoric acid, and vanadium trioxide.

9. A composition for staining an alkali surface as recited in claim 1, wherein the organic salt is urea hydrochloride.

10. A composition for staining an alkali surface as recited in claim 1, wherein a user selects the at least one metal salt to achieve a desired color combination for staining the alkali surface.

11. A composition for staining an alkali surface as recited in claim 1, wherein the alkali surface is concrete.

12. A composition for staining an alkali surface as recited in claim 1, wherein an aqueous solution of the composition is applied to the alkali surface.

13. A composition for staining an alkali surface as recited in claim 12, wherein the user coats the alkali surface with a sealant.

14. A composition for staining an alkali surface as recited in claim 13, wherein the sealant includes ultraviolet resistance.

15. A stained alkali surface, wherein the alkali surface is stained by the following process:
providing an organic salt;
mixing the organic salt with at least one metal salt to create a mixture;
applying the mixture to an alkali surface; and
rinsing the alkali surface with a solvent.

16. A stained alkali surface as recited in claim 15, wherein the organic salt is formed by the combination of at least one strong acid and at least one weak base, and wherein the at least one strong acid is one of: nitric acid, hydrochloric acid, hydorbromic acid, hydroiodic acid, hydrofluoric acid, formic acid, acetic acid, hydroxyacetic acid, and thioglycolic acid.

17. A stained alkali surface as recited in claim 16, wherein the at least one weak base is one of: urea, acetylurea, an alkonolamine, an alkylamine, an alkyltriamine, an alkyltetramine, a trialkylamine, a polymer having an amino substituent group, a polymer having a nitrogen-containing heterocyclic group, an amide, a cyclic amide, a pyrollidone, a polyvinyl pyrollidone, a copolymer of vinyl pyrollidone, a methacrylamide, a polymethacrylamide, a copolymer of methacrylamide, ammonia, guanidine, hydroxyurea, semicarbazide, methoxylamine, aniline, and hydrazine.

18. A stained alkali surface as recited in claim 15, wherein the metal salt is at least one of: sodium permanganate, ferrous chloride, ferric chloride, sodium dichromate, manganese chloride, cupric chloride, sodium sulphate, chromium potassium sulphate, potassium permanganate, black iron oxide, manganese oxide, red iron oxide, yellow iron oxide, ferric chloride solution, iron ore, sulfuric acid, barium sulfate, phosphoric acid, and vanadium trioxide.

19. A stained alkali surface as recited in claim 15, wherein the organic salt is urea hydrochloride.

20. A stained alkali surface as recited in claim 15, wherein the alkali surface is concrete.

21. A method of staining an alkali surface, the method comprising:
providing an organic salt;
mixing the organic salt with at least one metal salt; and
applying the mixture to an alkali surface.

22. The method of claim 21, further comprising:
rinsing the alkali surface with a solvent; and
coating the alkali surface with a sealant.

23. The method of claim 22, wherein the sealant includes ultraviolet resistance.

24. The method of claim 21, wherein the organic salt is formed by the combination of at least one strong acid and at least one weak base, and wherein the at least one strong acid is one of: nitric acid, hydrochloric acid, hydorbromic acid, hydroiodic acid, hydrofluoric acid, formic acid, acetic acid, hydroxyacetic acid, and thioglycolic acid.

25. The method of claim 24, wherein the at least one weak base is one of: urea, acetylurea, an alkonolamine, an alkylamine, an alkyltriamine, an alkyltetramine, a trialkylamine, a polymer having an amino substituent group, a polymer having a nitrogen-containing heterocyclic group, an amide, a cyclic amide, a pyrollidone, a polyvinyl pyrollidone, a copolymer of vinyl pyrollidone, a methacrylamide, a polymethacrylamide, a copolymer of methacrylamide, ammonia, guanidine, hydroxyurea, semicarbazide, methoxylamine, aniline, and hydrazine.

26. The method of claim 21, wherein the at least one metal salt is selected to achieve a desired color combination for staining the alkali surface.

27. The method of claim 26, wherein the metal salt is at least one of: sodium permanganate, ferrous chloride, ferric chloride, sodium dichromate, manganese chloride, cupric chloride, sodium sulphate, chromium potassium sulphate, potassium permanganate, black iron oxide, manganese oxide, red iron oxide, yellow iron oxide, ferric chloride solution, iron ore, sulfuric acid, barium sulfate, phosphoric acid, and vanadium trioxide.

28. A stained alkali surface as recited in claim 21, wherein the organic salt is urea hydrochloride.

29. The method of claim 21, wherein the alkali surface is concrete.

30. The method of claim 21, wherein said applying the mixture to the alkali surface comprises preparing and applying an aqueous solution of the mixture to the alkali surface.
